(19) United States
(12) Patent Application Publication
(10) Pub. No.: US 2020/0147808 A1
(43) Pub. Date: May 14, 2020

(54) SYSTEM AND METHOD FOR PROVIDING FEEDBACK IN ROBOTS

(71) Applicant: Realbotix, LLC, San Marcos, CA (US)

(72) Inventors: Susan Pirzchalski, San Marcos, CA (US); Matthew McMullen, San Marcos, CA (US)

(21) Appl. No.: 16/676,255

(22) Filed: Nov. 6, 2019

Related U.S. Application Data
(60) Provisional application No. 62/757,569, filed on Nov. 8, 2018.

(51) Int. Cl. B25J 11/00; B25J 19/02; B25J 13/08

(52) U.S. Cl. CPC B25J 11/0015; B25J 13/088; B25J 19/02; B25J 11/001

(57) ABSTRACT

Systems, devices, and methods for providing user feedback are disclosed. The device can include a housing having a hollow inner core extending from an outer opening to an inner end. The device can include a plurality of sensors disposed along an interior surface of the housing within the hollow inner core, operable to sense position of an object within the housing or pressure applied to an interior surface of the hollow inner core. The sensors can further sense depth of the object inserted into the hollow inner core. The device can have a controller communicatively coupled to the plurality of sensors and operable to receive sensor indications based on the position of the object within the housing provide various outputs based on the depth, position, pressure, etc. of the object within the hollow inner core.

### CROSS-REFERENCE TO RELATED APPLICATIONS

This application claims priority to U.S. Provisional Application Ser. No. 62/757,569, filed Nov. 8, 2018, entitled, “SYSTEM AND METHOD FOR PROVIDING FEEDBACK IN ROBOTS,” the contents of which are hereby incorporated by reference in their entirety.

### BACKGROUND

### Technical Field

This disclosure generally relates to robotic or animatronic dolls. More particularly, this disclosure relates to sensors and sensor systems that enable interactive feedback to a user.

### Related Art

Some artificial intelligence (AI) systems, including robotic or animatronic dolls are adapted for use as robotic friends or companions, however they lack sensory systems that provide feedback, for example, related to touch.

### SUMMARY

One aspect of the disclosure provides a device for providing feedback to a user. The device can include a housing having a hollow inner core extending from an outer opening to an inner end. The device can include a plurality of sensors disposed along an interior surface of the housing within the hollow inner core. The sensors can sense pressure applied to an interior surface of the hollow inner core. The sensors can sense depth of an object inserted through the outer opening into the hollow inner core. The device can have a controller communicatively coupled to the plurality of sensors. The controller can receive sensor indications from the plurality of sensors based on a position of the object within the hollow inner core. The controller can provide a first output based on a first position of the object within the hollow inner core. The controller can provide a second output different from the first output based on a second position of the object within the hollow inner core different from the first position. The plurality of sensors can sense a speed of movement of the object while the object is inserted into the hollow inner core. The controller can provide a third output based on the speed of movement. The first output and the second output can include a noise. The first output can be a voice output and the second output can be a louder voice output. The device can be a removable insert forming an orifice of a doll. The first output and the second output can cause the doll to perform at least one of the following actions: emit a noise, move an extremity, and move at least a portion of a doll head of the doll. The orifice can be one of a vagina, an anus, and a mouth. The controller can wirelessly communicate with a personality module of the doll. The controller can further cause the doll to perform an action based on the personality module.

Another aspect of the disclosure provides a simulated orifice device for a doll. The simulated orifice device can have a housing having a hollow core extending from an outer opening to an inner end, the housing configured to be received within the doll to form an orifice of the doll. The simulated orifice device can have a plurality of sensors disposed along an interior surface of the housing within the hollow inner core. The sensors can sense pressure applied to an interior surface of the hollow core. The sensors can sense depth of an object inserted through the outer opening into the hollow core. The simulated orifice device can have a controller communicatively coupled to the plurality of sensors. The controller can receive sensor indications from the plurality of sensors based on a position of the object within the hollow core. The controller can provide a first output based on a first position of the object within the hollow core. The controller can provide a second output different from the first output based on a second position of the object within the hollow inner core different from the first position.

Another aspect of the disclosure provides a sex toy. The sex toy can have a housing having an inner cavity extending from an outer opening to an inner end, the housing resembling an orifice of a human. The sex toy can have a plurality of sensors disposed along an interior surface of the housing within the inner cavity. The sensors can sense pressure applied to an interior surface of the inner cavity. The sensors can sense depth of an object inserted through the outer opening into the inner cavity. The sex toy can have a controller communicatively coupled to the plurality of sensors. The controller can receive sensor indications from the plurality of sensors based on a position of the object within the inner cavity. The controller can provide a first output based on a first position of the object within the inner cavity. The controller can provide a second output different from the first output based on a second position of the object within the inner cavity different from the first position.

Another aspect of the disclosure provides a method for providing feedback in a doll. The method can include sensing a first condition at one or more sensors of a plurality of sensors, the plurality of sensors being disposed along an interior surface of a hollow inner core extending from an outer opening to an inner end of a housing, the first condition including a presence of an object within the hollow inner core. The method can include sensing a second condition at the one or more sensors, the second condition including a second position of the object different from the first position. The method can include causing, by one or more processors communicatively coupled to the plurality of sensors. The method can include a first output based on a first position of the object within the hollow inner core. The method can include a second output different from the first output based on the second position of the object within the hollow inner core. The plurality of sensors are configured to sense at least one of pressure applied to the interior surface, a speed of movement of the object, and a depth of the object inserted through the outer opening into the hollow inner core.

Other features and advantages will be apparent to one of ordinary skill in the art with a review of the following description.

### BRIEF DESCRIPTION OF THE DRAWINGS

The details of embodiments of the present disclosure, both as to their structure and operation, can be gleaned in part by study of the accompanying drawings, in which like reference numerals refer to like parts, and in which:

FIG. 1 is a graphical representation of a robotic doll;

FIG. 2 is a functional block diagram of a device for use in the doll of FIG. 1;

FIG. 3 is a functional block diagram of a removable insert of the doll of FIG. 1;

FIG. 4 is a cutaway view of an embodiment of the insert of FIG. 3;

FIG. 5 is graphical depiction of the outer opening of an embodiment of the insert of FIG. 3;

FIG. 6 is graphical depiction of the outer opening of another embodiment of the insert of FIG. 3; and

FIG. 7 is a cross section taken along the line 7-7 of FIG. 4.

### DETAILED DESCRIPTION

The detailed description set forth below, in connection with the accompanying drawings, is intended as a description of various embodiments and is not intended to represent the only embodiments in which the disclosure may be practiced. The detailed description can have specific details for the purpose of providing a thorough understanding of the embodiments. In some instances, well-known structures and components are shown in simplified form for brevity of description.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

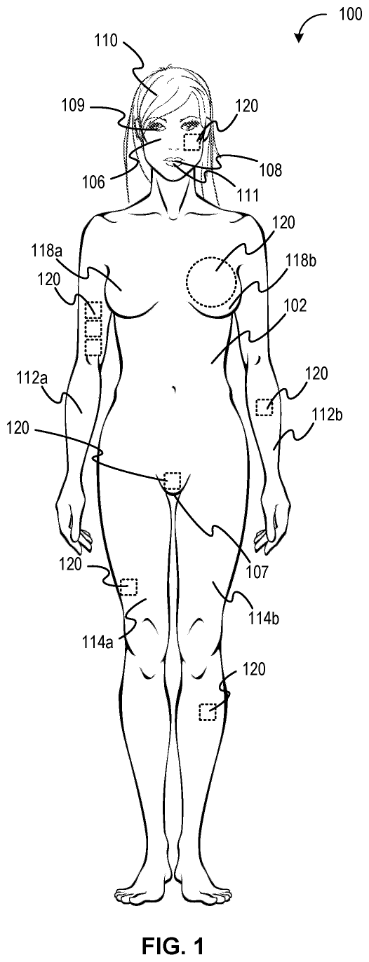

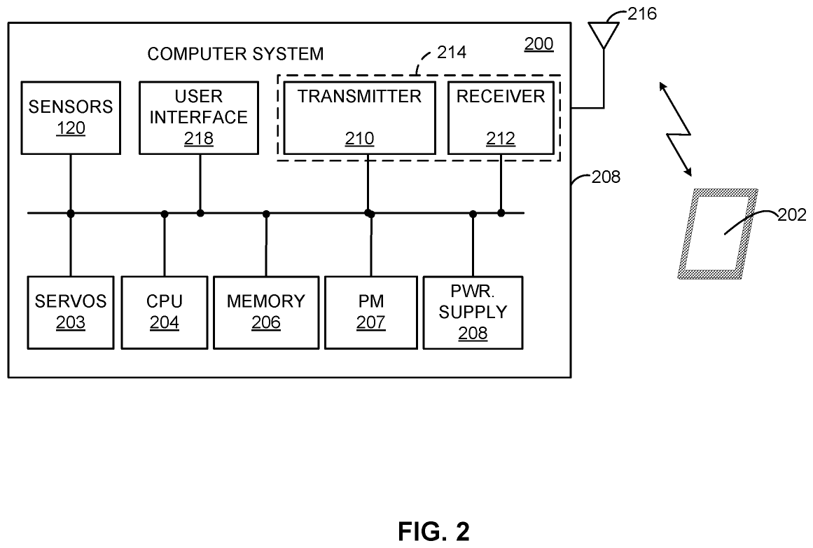

FIG. 1 is a graphical representation of a robotic doll. A robotic doll (doll) 100 can have all of the normal features of a human body. A female anatomy is shown in the doll 100 however, a male doll is an alternative embodiment. Other creatures, animals, aliens, or physical beings are also possible embodiments. The doll 100 can have a doll head 110. The doll head 110 can be a fully articulated robotic design having a movable mouth 108 and eyes 109 operable to interact with a user. The doll head 110 can be similar to that described in U.S. Pat. No. 8,888,553, issued Nov. 18, 2014, entitled “DOLL HEAD HAVING A MAGNETICALLY ADJUSTABLE FACIAL CONTOUR AND METHOD OF ASSEMBLING SAME,” the entirety of which is hereby incorporated by reference. The doll head 110 can provide facial expressions, talk, and move the mouth 108, lips 111, and portions of a face 106 (e.g., cheeks, forehead, etc.) according to the speech and emotion in conversation with the user. The doll head 110 can have multiple internal components, one or more computers, and associated circuitry for interaction according to AI systems (see FIG. 2). As described herein, other systems (e.g., wireless mobile device or computer) can be communicatively coupled to the internal computers or processors to allow for distributed processing as needed to provide a life-like simulation by the doll 100.

The doll 100 can have first extremities (arms) 112 (shown as arm 112a and arm 112b) and second extremities (legs) 114 (shown as leg 114a and leg 114b). The doll 100 can further have a torso 102 having all of the common characteristics of a human body. As used herein the “body” of the doll 100 can collectively describe all of the various parts of the doll 100. Some implementations of the doll 100 can include animals or other creatures such as aliens. Accordingly, the first extremities 112 and the second extremities 114 can be legs. In still other implementations there can be more or fewer than four extremities 112, 114. Some versions of the doll 100 can have one, two, or three extremities as needed.

In general, the doll 100 can have an internal skeleton with several layers of different compositions of silicon-based or polymeric substances to provide an anatomically correct construction with a life-like touch and feel of every aspect of the doll 100. For example, silicon and latex may comprise a portion of the skin and flesh of the doll 100 over the skeleton.

A plurality of sensors 120 can be distributed about the body of the doll 100. The sensors 120 are shown in various places distributed about the body of the doll 100. The sensors 120 can be one or more of a capacitive touch sensor, an optical sensor (e.g., laser or infrared), sonar or radar, fluid or pneumatic pressure transducers, mechanical stretch detection, an accelerometer or gyroscope (e.g., to measure instantaneous motion and relative position). The sensors 120 can be a component of the doll 100 placed on, within, or below the skin to sense changes in the surrounding environment due to touch, temperature, pressure, movement, etc. In some embodiments, the sensors 120 can be small or large patches or varying size and shape distributed on the body of the doll 100. For example, the sensors 120 can be placed on or within the arms 112, the legs 114, the torso 102, face 106, breasts 118 (labeled as breasts 118a, 118b), or any other desired part of the body/doll 100. In some embodiments, the sensors 120 can be placed within, for example, the doll head 110 or limbs to sense motion (e.g., an accelerometer). Motion can further be sensed as multiple sensors 120 can detect touch and thus sense, for example, the user's hand as it moves from one portion of the body to another. Only a few sensors 120 are shown in this example, however the sensors 120 can cover a portion, all, or substantially all of the body of the doll 100.

In some embodiments, the sensors 120 can be substantially continuous about the skin of the doll 100. For example, the sensors 120 can be placed on the skin to sense touch on a continuous basis across some or all of the body of the doll 100.

In some embodiments, the sensors 120 can also be placed inside various orifices of the doll 100, such as the mouth 108, vagina 107, and anus (not shown). In such an example, the sensors 120 can be adapted to determine insertion depth, location, pressure against an interior surface of the orifice, and insertion speed of an object inserted in the respective orifice.

In some implementations, the sensors 120 can provide feedback to the user based on touch, for example. The doll 100 can move the head 110, the arms 112, and/or the legs 114 according to feedback or indications from one or more of the sensors 120. This can also include changing facial expressions (e.g., on the face 106) according to indications from the sensors 120. In some encounters, the user may touch the doll 100, and based on the pressure, location of the touch, and type of touch, and certain aspects of the programming or artificial intelligence (AI) of the doll 100 may provide an appropriate or desired response to the user. Such a response can be a sound, a facial expression, a physical action with a limb, or other interactive response.

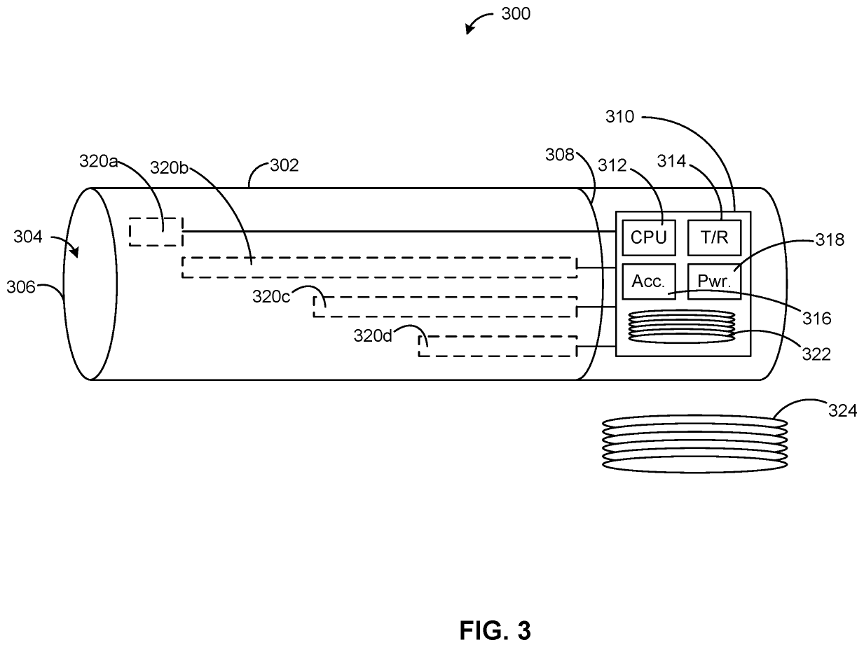

FIG. 2 is a functional block diagram of a device for use in the doll of FIG. 1. A device 200 is an embodiment of a device that can be configured to implement the various methods described herein. For example, the device 200 can include the doll 100. The device 200 can further include the insert 300 of FIG. 3, for example. The insert 300 may also be referred to as an insert device 300 or just device 300.

The device 200 can include one or more processors or processor units (processor) 204. The processor 204 can control operation of the device 200. The processor 204 can also be referred to herein as a central processing unit (CPU). The processor 204 can include or be a component of a processing system implemented with one or more processors 204. The one or more processors can be implemented with any combination of general-purpose microprocessors, microcontrollers, neural processing units (NPUs), digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information. The processors 204 can also perform quantum computing functions as well.

The device 200 can also have a memory 206 coupled to the processor 204. The memory 206 can include both read-only memory (ROM) and random access memory (RAM). The memory 206 can provide instructions and data to the processor 204.

At least a portion of the memory 206 can also include non-volatile random access memory (NVRAM). The processor 204 can perform logical and arithmetic operations based on program instructions stored within the memory 206. The instructions in the memory 206 can be executable to implement the methods described herein. The processor 204 and the memory 206 can also include machine-readable media for storing software. Software shall be construed broadly to mean any type of instructions, whether referred to as software, firmware, middleware, microcode, hardware description language, machine learning, AI, or otherwise. Instructions can include code (e.g., in source code format, binary code format, executable code format, or any other suitable format of code). The instructions, when executed by the one or more processors, cause the processing system to perform the various functions described herein.

In some implementations, the device 200 can have a personality module (PM) 207. The PM 207 can include one or more memories or software modules that perform functions related to the AI of the doll 100. In some embodiments, the PM 207 can be implemented to store, for example, data related to the operation of the AI of the doll 100. Thus, the PM 207 can be said to store the personality of the doll 100. The PM 207 can store instructions that cause the doll 100 to perform various actions in response to conditions detected by the sensors 120.

The device 200 can also have one or more servos 203. The servos 203 can be implemented to move one or more moveable features of the doll head 110 such as the extremities 112, 114, the doll head 110, the eyes 109, the mouth 108, and/or the lips 111, for example. The processor 204 and the PM 207 can operate in conjunction to control one or more servos 203 that drive facial expressions on the face 106 or movement of one or more extremities 112, 114. In addition, the processor 204 and the PM 207 can operate in conjunction to control aural or audible output of the doll 100, for example from one or more speakers (e.g., the UI 218) of the doll 100 (e.g., inside the doll head 110). The noises, exclamations, or other speech can be coordinated with movement of, for example, the lips 111 and mouth 108 as needed.

The device 200 can also have a power supply 208. The power supply 208 can perform a power storage function for powering the various systems within the device 200. The power supply can be a battery in some embodiments or a wired power supply in others. The power supply can also perform charging operations to recharge a battery or other power storage device. The power supply 208 can further recharge via one or more wireless or inductive power supply systems.

The device 200 can also include a transmitter 210 and/or a receiver 212 to allow transmission and reception of data between the device 200 and a remote location. The transmitter 210 and the receiver 212 can be combined into a transceiver 214. The device 200 can also have one or more antennas 216 electrically coupled to the transceiver 214. The device 200 can also include (not shown) multiple transmitters, multiple receivers, multiple transceivers, and/or multiple antennas as needed for various communication standards. In some embodiments, the doll 100 (e.g., the processor 204) can communicate with a user device 202. The user device 202 can be a wireless mobile device operable or otherwise configured to communicate wirelessly with the doll 100. Such wireless communication can be conducted to convey instructions to one or more processors that perform functions related to the AI of the doll 100 to perform specific actions or to modify one or more options of one or more behaviors of the doll 100 (e.g., language, accent, personality, actions, reactions to various stimuli, etc.). In some implementations, the doll 100 can have a personality module including instructions that govern interactions with or reactions from the doll 100. Such a personality module can have various machine learning capabilities and operate based on an AI system.

The transmitter 210 can be configured to wirelessly transmit packets having different packet types or functions. For example, the transmitter 210 can be configured to transmit packets of different types generated by the processor 204. For example, the processor 204 can be configured to determine the type of packet and to process the packet and/or fields of the packet accordingly. The processor 204 can be configured to generate a discovery packet including a discovery message, beacon, or other information, and to determine what type of packet information to use in a particular instance.

The receiver 212 can be configured to wirelessly receive packets or other information having different packet types. In some examples, the receiver 212 can be configured to detect a type of a packet used and to process the packet accordingly.

In some embodiments, the transmitter 210 and the receiver 212 can be configured to transmit and receive information via other wired or wireline systems or means to and from the user device 202.

The device 200 can further include a user interface 218. The user interface 218 or UI 218 can include a keypad, a microphone, a speaker, and/or a display. The user interface 218 can include any element or component that conveys information to a user of the device 200 and/or receives input from the user. The user interface 218 can be used to listen to or otherwise receive verbal questions, statements, or commands from a user. The user interface 218 can further include one or more speakers to project sounds, such as speech or other noises from the doll 100. In some embodiments, the user interface 218 can be provided or otherwise displayed at the user device 202.

The device 200 can further communicate with the sensors 120. The sensors 120 can be multiple small sensors distributed about the doll 100 or can be fewer large sensors covering large portions of the body as needed. In some embodiments, the sensors 120 can receive power from the power supply 208 as needed.

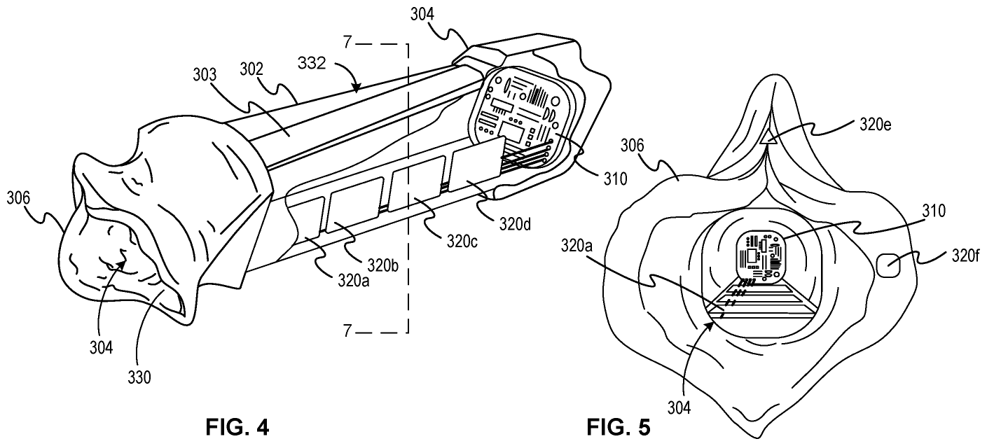

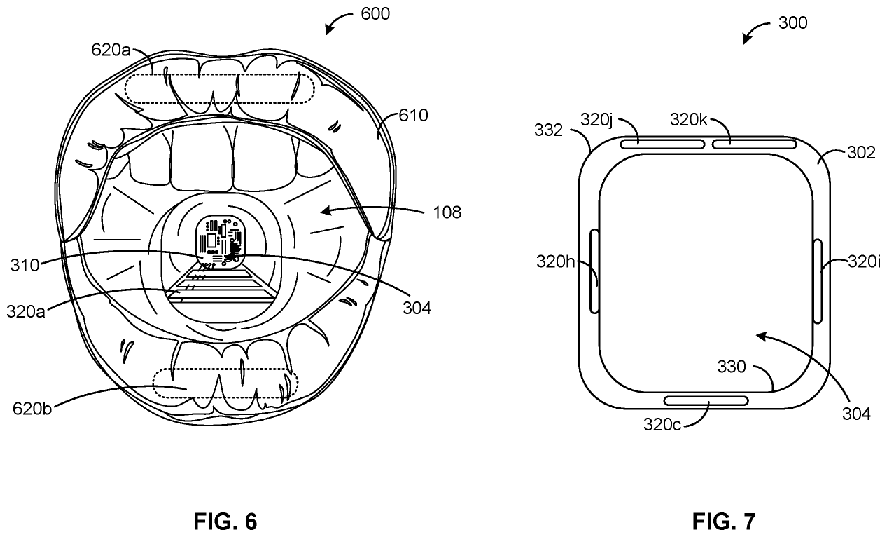

FIG. 3 is a functional block diagram of a removable insert of the doll of FIG. 1. An insert 300 can have a housing 302. The housing 302 can have a flexible construction, formed from silicon-based substances or other polymeric materials. The housing 302 can be formed as a sleeve or have a tubular or cylindrical shape having a hollow inner core 304 and one or more structural members 303 (FIG. 4) to provide structural support or a degree of stiffness. The structural members 303 can be formed from similar materials as the housing 302. The inner core 304 can be an inner cavity that extends from an outer opening 306 to an inner end or closed end 308. The insert 300 can be formed to simulate an orifice (e.g., a vagina) that is insertable to (e.g., and removable from) the doll 100. In some other embodiments, the insert 300 can also be formed as a mouth (e.g., the mouth 108, see FIG. 6), insertable into the head 110 of the doll 100. The insert 300 can also be formed as an anus, insertable into the rear of the doll 100. The insert 300 can have an inner surface 330 (FIG. 4, FIG. 5, FIG. 7) that is continuous within the inner core 304 that simulates the interior of a desired orifice, for example. The insert 300 can further have an outer surface 332. The inner surface 330 and the outer surface 332 can define a thickness of the housing 302.

The inner end 308 of the insert 300 can be adjacent to a control system 310. In some implementations, the control system 310 can be disposed opposite the opening 306. The control system 310 can also be disposed in other locations of the insert 300, as needed. The control system 310 can include a controller 312. The controller 312 is labeled as CPU (central processing unit) 312 for simplicity, but can perform functions similar to a CPU. The controller 312 can thus be similar to the processor 204 and perform similar functions for the control and processing for the insert 300. The control system 310 can also have a transmitter/receiver (transceiver) 314. The transceiver is labeled T/R for simplicity. The transceiver 314 can communicate wirelessly with the device 200. In embodiments, the transceiver 314 can further communicate wirelessly with the user device 202. Such communications can enable configurability of the insert 300 for different implementations or user preferences.

In some implementations, the transceiver 314 can also include an audio transceiver. The transceiver 314 can therefore be configured as a speaker. The speaker of the transceiver 314 can emit audio signals (e.g., noises). Such audio signals can include human voices or animal noises, for example. The transceiver 314 can further receive voice commands. Such voice commands can be received and transmitted to, for example, the device 200 or the user device 202 and used for configuring the device 300.

The control system 310 can have at least one accelerometer 316. The accelerometer 316 can sense movement, speed, rate of change in position, acceleration, etc. of the device 300 and of objects inserted into the inner core 304.

The control system 310 can further have a power supply 318. The power supply 318 can be a power storage device (e.g., a battery) similar to the power supply 208 (FIG. 2). The power supply 318 can be coupled to a wireless charger 322. The wireless charger 322 can receive a charging field (e.g., inductive field) from a wireless charger 324. In some embodiments, the wireless charger 324 can be disposed within the doll 100. For example, when the insert 300 is formed as a vagina for the doll 100, the insert may receive wireless power from the wireless charger 324 disposed within, for example, the lower torso 102 (e.g., abdomen, pubic region) of the doll 100. When the insert 300 is formed as a mouth (e.g., FIG. 6), the insert may receive wireless power from the wireless charger 324 disposed within, for example, the head, neck, or upper torso region of the doll 100.

In some implementations, the wireless charger 322 can be disposed outside the doll 100. For example, in some embodiments, the insert 300 can be used as a standalone sex toy, external from the doll 100. In such an example, the wireless charger 322 can be a standalone device for charging the power supply 318 of the insert 300. In some embodiments, the insert 300 can further have a wired power port for receiving charging power at the power supply 318.

The insert 300 can have a series of sensors 320 lining the inside of the inner core 304. Four sensors 320 are shown, labeled sensors 320a, 320b, 320c, and 320d. The sensors 320 are drawn in dashed lines indicating their position inside the inner core 304. The sensors 320 can be communicatively coupled to the control system 310. The sensors 320 can further receive power from the control system 310.

The sensors 320 can be operable to sense pressure, touch, movement, speed, etc. within the inner core 304. For example, the sensors 320 can sense the presence of a finger, a penis, or other insertable object (e.g., a sex toy) into the inner core 304. The housing 302 can be formed to withstand repeated human sexual use. In some implementations, the sensors 320 can individually sense pressure and relay associated inputs to the controller 312. The controller 312 can interpret such pressure indications from a single sensor 320 or over multiple sensors 320 to detect movement and speed, for example.

The sensors 320 can be disposed at different positions and different depths within the inner core 304. The control system 310 (e.g., the controller 312) can thus sense a depth of the inserted object within the inner core 304. In some embodiments, the controller 312 can sense depth, movement, speed, and pressure, among other aspects. The positioning of multiple of the sensors 320 within the insert 300 can cause different reactions or responses from the doll 100 (e.g., the doll head 110) based on responses from the sensors 120. In some implementations, the positioning of multiple of the sensors 320 within the insert 300 can cause different reactions or responses from the device 300 (e.g., via the transceiver 314) based on responses from the sensors 320.

In embodiments in which the insert 300 is implemented as a vagina within the doll 100, the controller 312 can communicate information from the sensors 320 to the processor 204. The processor 204 can then perform specific functions for the doll 100. In some examples, the processor 204 can cause the doll head 110 to display a specific facial expression, make a specific or preprogrammed noise, or take other action.

In some embodiments, the doll 100 may move one or more limbs or other body parts in response to information received from the sensors 320.

In embodiments in which the insert 300 is implemented as a standalone sex toy, the control system 310 can communicate with the processor 204 (e.g., the doll 100) and provide aural feedback from the doll head 110 or the user device 202, based on the user's actions with the insert 300. In some implementations, the transceiver 314 can provide aural feedback based on the user's actions with the insert 300 when used as a standalone device.

In embodiments, the insert 300 can be included as an integral portion of the doll 100. For example, the insert 300 can be included in the original construction or formation of the doll 100 as needed.

FIG. 4 is a cutaway view of an embodiment of the insert of FIG. 3. FIG. 5 is an elevation view of the outer opening of an embodiment of the insert of FIG. 3. FIG. 4 and FIG. 5 are referenced in the following description.

The device 300 can be a vaginal simulator sex toy with sensing capabilities. As described above, the device 300 can be inserted into the doll 100 and serve as an orifice of the doll 100 (e.g., a vagina, mouth, or anus). In another embodiment, the insert 300 can be a standalone sex toy with sensing and wireless communication capabilities. In some implementations the device 300 can be communicatively coupled to the user device 202 (FIG. 2). The user device 202 can implement certain applications or apps to adjust reactions to conditions sensed by the sensors 320. The sensors 320 are shown with portions of the outer layer (e.g., the outer surface 332) of the insert 300 removed in FIG. 4. Portions of outer surface 332 of the insert 300 are removed in this view to show the controller 310 as well.

Other sensors 320e and 320f can be placed as needed surfaces near the entrance of the inner core 304. For example, the sensor 320e can be placed at or near the clitoris, while one or more sensors 320 (e.g., the sensor 320f) can be positioned on an exterior portion of the simulated vagina such as the vulva.

The sensors 320 can be placed anywhere on the surface or slightly below the surface of the insert 300 as needed. The sensors 320 can be embedded within an outer layer of “skin” (see FIG. 7) within the inner core 304, or on the exterior of the doll 100. The sensors 320 can be sized to provide varying levels of sensitivity. For example, smaller sensors 320 can be implemented and densely clustered in areas that should be highly sensitive, such as the clitoris (the sensor 320f), breasts 118, or the lips 111. On the other hand, larger sensors 320 or less densely clustered sensors 320 can be implemented on less sensitive areas, such as the extremities 112, 114.

In some implementations, the insert 300 can be a self-contained prosthesis (made from silicone or other compliant material) which simulates the look and feel of a human vagina as shown in FIG. 4 and FIG. 5. The embedded sensors 320 can be integrated with on-board microprocessor (e.g., the control system 310) and transmit sensor data to another computer such as the processor 204 (e.g., device 200) or the user device 202. The sensors 320 can measure the depth, pressure against the interior of the insert, etc. within the inner core 304 of an insertable object (penis, finger, other sex toy, etc.) as well as the speed/rate of insertion.

The device 200 or the user device 202 can run an application that causes the device 200 or the user device 202 to communicate with the insert 300. The application can be run or operated on a smartphone, tablet, or other external computer (e.g., the user device 202) that can establish a connection via a wired or wireless link to the insert 300. The processor 204 or the user device 202 running the application can collect the sensor data transmitted by the insert 300 (e.g., the sensors 320) and cause the doll 100 to perform a response. For example, the response can include an appropriate vocal cue or facial expression as programmed.

FIG. 6 is a graphical representation of another embodiment of the insert of FIG. 3. An insert 600 can be similar to the insert 300 (FIG. 4, FIG. 5). The insert 600 can be equipped with lips 610. The lips 610 can be similar to the lips 111 of the doll head 110 (FIG. 1). The insert 600 shown in FIG. 6 can be received within the head 110 and serve as the mouth 108 (FIG. 1). The insert 600 can have sensors 620 embedded or otherwise applied to the lips 111. The sensors 620 can be similar to the sensors 320, described herein. The sensors 620 are shown in dotted lines indicating being embedded within the surface of the lips 610, similar to the sensors 320 (see FIG. 7).

FIG. 7 is a cross section taken along the line 7-7 of FIG. 4. The cross section shown in FIG. 7 can be a cross section of any of the embodiments of the insert 300 described herein, such as the vaginal insert of FIG. 4 and FIG. 5, the mouth insert 600 of FIG. 6, or an anus insert as needed. The insert 300 can have a plurality of the sensors 320 embedded within the structure of the housing 302. For example, the sensors 320c, 320j, 320k can be separated from the inner surface 330 further than the sensors 320h, 320i. The sensors 320h, 320i are shown at or near the inner surface 330, for example. The depth beneath the inner surface 330 of the inner core 304 can be varied according to desired sensitivity of the specific sensor(s) 320. In addition, the sensors 320 can be spaced as needed according to desired sensitivity, as the sensor 320j adjacent the sensor 320k. This is also shown for the sensors 120 of FIG. 1. The sensors 320 sensors 120 can be molded or case within the skin or housing 302 or mounted on the doll 100 or the insert 300 to the surface (e.g., the inner surface 330) as needed. In various implementations of the mouth insert 600, the sensors 620 can be embedded within the lips 610 or other parts of the inner core 304.

Those of skill will appreciate that the various illustrative logical blocks (e.g., the various servers described herein), modules, and algorithm steps described in connection with the embodiments disclosed herein can often be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the design constraints imposed on the overall system. Skilled persons can implement the described functionality in varying ways for each particular application, but such implementation decisions should not be interpreted as causing a departure from the scope of the disclosure. In addition, the grouping of functions within a module, block or step is for ease of description. Specific functions or steps can be moved from one module or block without departing from the disclosure.

The various illustrative logical blocks and modules (e.g., the various servers described herein) described in connection with the embodiments disclosed herein can be implemented or performed with a general purpose processor, a digital signal processor (DSP), application specific integrated circuit (ASIC), a field programmable gate array (FPGA) or other programmable logic device, discrete gate or transistor logic, discrete hardware components, quantum computers, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such that the processor can read information from, and write information to, the storage medium. In the alternative, the storage medium can be integral to the processor. The processor and the storage medium can reside in an ASIC.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method blocks or elements identified, but that such blocks or elements do not comprise an exclusive list and a method or apparatus may contain additional blocks or elements.

It will be understood that the above descriptions of various embodiment are given by way of example and not by limitation. Accordingly, various modifications may be made by those skilled in the art. Although various embodiments have been described above with a certain degree of particularity, or with reference to one or more individual embodiments, those skilled in the art could make numerous alterations to the disclosed embodiments without departing from the spirit or scope of this disclosure.

The above description of the disclosed embodiments is provided to enable any person skilled in the art to make or use the subject matter disclosed. Various modifications to these embodiments will be readily apparent to those skilled in the art, and the generic principles described herein can be applied to other embodiments without departing from the spirit or scope of the disclosure. Thus, it is to be understood that the description and drawings presented herein represent a presently preferred embodiment of the disclosure and are therefore representative of the subject matter, which is broadly contemplated. It is further understood that the scope of the present disclosure fully encompasses other embodiments that may become obvious to those skilled in the art.

What is claimed is:

1. A device for providing feedback to a user, comprising:
a housing having a hollow inner core extending from an outer opening to an inner end;
a plurality of sensors disposed along an interior surface of the housing within the hollow inner core and configured to
sense pressure applied to an interior surface of the hollow inner core, and
sense depth of an object inserted through the outer opening into the hollow inner core;
a controller communicatively coupled to the plurality of sensors and configured to
receive sensor indications from the plurality of sensors based on a position of the object within the hollow inner core,
provide a first output based on a first position of the object within the hollow inner core, and
provide a second output different from the first output based on a second position of the object within the hollow inner core different from the first position.

2. The device of claim 1, wherein plurality of sensors are further configured to sense a speed of movement of the object while the object is inserted into the hollow inner core.

3. The device of claim 2, wherein the controller is further configured to provide a third output based on the speed of movement.

4. The device of claim 1, wherein the first output and the second output comprise a noise.

5. The device of claim 4, wherein the first output is a voice output and the second output is a louder voice output.

6. The device of claim 1, wherein the device comprises a removable insert forming an orifice of a doll.

7. The device of claim 6, wherein the first output and the second output cause the doll to perform at least one of the following actions: emit a noise, move an extremity, and move at least a portion of a doll head of the doll.

8. The device of claim 6, wherein the orifice is one of a vagina, an anus, and a mouth.

9. The device of claim 6, wherein the controller is further configured to wirelessly communicate with a personality module of the doll.

10. The device of claim 9 wherein the controller is further configured to cause the doll to perform an action based on the personality module.

11. A simulated orifice device for a doll, comprising:
a housing having a hollow core extending from an outer opening to an inner end, the housing configured to be received within the doll to form an orifice of the doll;
a plurality of sensors disposed along an interior surface of the housing within the hollow inner core and configured to
sense pressure applied to an interior surface of the hollow core, and
sense depth of an object inserted through the outer opening into the hollow core;
a controller communicatively coupled to the plurality of sensors and configured to
receive sensor indications from the plurality of sensors based on a position of the object within the hollow core,
provide a first output based on a first position of the object within the hollow core, and
provide a second output different from the first output based on a second position of the object within the hollow inner core different from the first position.

12. The simulated orifice device of claim 11, wherein plurality of sensors are further configured to sense a speed of movement of the object while the object is inserted into the hollow core.

13. The simulated orifice device of claim 12, wherein the controller is further configured to provide a third output based on the speed of movement.

14. The simulated orifice device of claim 11, wherein the housing comprises a removable insert forming an orifice of the doll.

15. The simulated orifice device of claim 14, wherein the first output and the second output cause the doll to perform at least one of the following actions: emit a noise, move an extremity, and move at least a portion of a doll head.

16. The simulated orifice device of claim 14, wherein the orifice is one of a mouth, a vagina, and an anus.

17. A sex toy comprising:
a housing having an inner cavity extending from an outer opening to an inner end, the housing resembling an orifice of a human;
a plurality of sensors disposed along an interior surface of the housing within the inner cavity and configured to
sense pressure applied to an interior surface of the inner cavity, and
sense depth of an object inserted through the outer opening into the inner cavity;
a controller communicatively coupled to the plurality of sensors and configured to
receive sensor indications from the plurality of sensors based on a position of the object within the inner cavity,
provide a first output based on a first position of the object within the inner cavity, and
provide a second output different from the first output based on a second position of the object within the inner cavity different from the first position.

18. The sex toy of claim 17, wherein plurality of sensors are further configured to sense a speed of movement of the object while the object is inserted into the inner cavity.

19. The sex toy of claim 18, wherein the controller is further configured to provide a third output based on the speed of movement.

20. The sex toy of claim 17, wherein the first output and the second output comprise a voice.
